(19) United States
(12) Patent Application Publication
(10) Pub. No.: US 2012/0242092 A1
(43) Pub. Date: Sep. 27, 2012

(54) High Security Exit System

(76) Inventors: George Frolov, Farmington, CT (US); James J. Scott, New Britain, CT (US)

(21) Appl. No.: 13/430,290

(22) Filed: Mar. 26, 2012

Related U.S. Application Data
(60) Provisional application No. 61/468,016, filed on Mar. 27, 2011.

(51) Int. Cl. E05B 65/10; E05B 47/00

(52) U.S. Cl. 292/92

(57) ABSTRACT

A high security exit system employs a door latching assembly which cooperates with a frame latching assembly mounted to the door frame. The frame latch is mounted for pivotal movement and has a latching surface movable toward a projected position. When the door is closed, the door and frame latching surfaces are projected and engaged in opposed surface-to-surface orientation. A direction of force resulting from an attempt to forcibly disengage the latching surfaces is directed through or close to the pivot access of the door latch. An override assembly is provided to force the frame latch to a retracted position when the door is opened. Auxiliary latch assemblies and corresponding frame latch assemblies are provided for coordinated latching and retraction when the push bar retracts the primary door latch. Dual latch assemblies are also provided. A solenoid mechanism may be employed to dog the push bar.

### CROSS-REFERENCE TO RELATED APPLICATION

This application claims the priority of U.S. Provisional Patent Application No. 61/468,016 filed on Mar. 27, 2011, the disclosure of which is incorporated herein by reference in its entirety.

### BACKGROUND

This disclosure relates generally to exit devices which are adapted for use in facilitating the egress from a building in an emergency situation such as fire. More particularly, this disclosure relates to exit bars which are mounted to exit doors and are depressible to retract a latch.

Conventional exit bars to which the present disclosure relates employ a pivoted latch which is attached to a door. A fixed strike is mounted to the door frame. A horizontal bar is disposed across the door and is configured to retract the latch upon depressing the bar. The pivoted latch is a Pullman-type mechanism which is pivoted so that when it is pressed against the strike, it tends to rotate the latch into a closed position. The contacting surface of the latch is defined by a constant radius from the pivot axis. When the horizontal bar is depressed, the latch rotates into an opposite direction and the rotational movement of the latch facilitates releasing the latch even under a considerable pressure.

The conventional-type of latching can be deficient when a substantial pulling force is applied from outside to the door. In this instance, the rounded surface of the latch pressed against the strike simply functions as a wedge, spreading apart the door and the door frame enough to disengage the strike and the latch essentially without moving anything else. In sum, the typical conventional latch can be fairly characterized as a compromise between a moderate degree of security and excellent safety.

There are, however, numerous applications in which it is required that the latching devices be capable of withstanding tremendous pressure, such as may be applied to doors by hurricanes and tornadoes, while still providing an efficient and easy egress from the inside of the structure. In addition, security has become a significantly greater consideration, and there is a growing concern that it should not be unduly compromised.

The subject exit system addresses problems associated with conventional devices by implementing a number of new approaches:

First, both the latch and the strike are pivoted. The latch is pivoted in a way that, when under pressure to open the door, the latch pressed against the strike, which is blocked from rotation in a direction allowing door opening, tends to rotate in a direction to allow the door to open. However, the latch is configured in a “claw” like configuration, so that any would be rotating force theoretically goes through the center of rotation, and therefore is not effective in causing any rotation. In practice, the relationships may deviate from the theoretical model and the force is somewhat offset from the center of rotation. Consequently, there is a back up feature, blocking the claw-like latch, until the slightly depressed bar releases the blocking allowing rotation. When released, the latch is subject to two retracting forces—the pressure by the continuous movement of the bar and any force applied to the door from the inside or the outside in the direction of the opening. After the door is open and the bar is no longer pressed down, the door could be relocked. The one way pivoted strike allows re-latching.

Second, the physical strength of a door/door frame system depends on the number of points where the door locks to the frame, regardless of the push bar design. Conventional related devices typically provide, at most, three points for a single door and two for a pair of doors. The proposed bar allows theoretically unlimited number of locking points all to be operated simultaneously by a single horizontal push bar. As practical constraints, the number of locking points would be limited by a force required for the bar to overcome resistance of the spring loaded latches and still be within activation force limits of regulatory codes.

### SUMMARY

Briefly stated, an exit bar system releasably secures a door to a door frame. The door is pivotal about a pivot axis between a closed and opened position and mounts a push bar on the secured side of the door. A door latching assembly mounted on the secured side of the door comprises a door latch mounted for pivotal movement about an axis parallel to the pivot access. The door latch has a door latching surface movable between a retracted position and a projected position. A frame latching assembly mounted to the door frame comprises a frame latch mounted for pivotal movement about an axis parallel to the frame. The frame latch has a frame latching surface movable toward a projected position. When the door is in the closed position relative to the door frame, the door and frame locking surfaces are projected and engaged in adjacent opposing surface-to-surface orientation such that a direction of force resulting from an attempt to externally forcibly disengage the latching surfaces is directed across or close to the axis of the door latch.

In one embodiment, the door latching surface has a claw-like configuration, and the frame latching surface is generally complementary to the claw-like configuration. The door and frame latching surfaces in projected positions engage along an interface generally parallel to the door. The door latching assembly comprises dual transversely spaced door latches and the frame latching assembly also comprises two transversely spaced frame latches generally opposite the door latches.

Upon depressing the push bar, the door latch is forced to a retracted position via a longitudinal translation of a slide assembly. The door latching assembly comprises a platform with a peripheral skirt defining a recess. A longitudinally reciprocating actuator is disposed in the recess. The actuator comprises a pair of transversely spaced extensions which each define a diagonal slot.

A pair of actuating rods extend vertically relative to the latching assembly. A pin is received in each of the slots for vertically moving the actuator rods upon longitudinal movement of the actuator. A pair of transversely spaced, substantially identical latch housings each have a pair of transversely spaced upright walls. Each of the housings has a latch pivotally mounted via a pin received in an aperture of the walls. A coil spring is wrapped around each pin. The spring biases each of the latches to a generally projected position.

A carrier is disposed between the housing walls and is longitudinally slidable relative to the housing. The carrier further connects with a contraction arm pivotally mounted to the door latch wherein longitudinal movement of the carrier forces the door latch to retract rearwardly into the latch housing. A longitudinally movable actuator is operatively connected to the push bar. The carrier is fastened to the actuator.

The frame latching assembly comprises a frame latch biasing mechanism to bias the frame latch to a projected position. The frame latching assembly further comprises an override assembly which is biasable to overcome the frame latch biasing mechanism to retract the frame latch to a retracted position. The override assembly comprises a biasable member. The door latching assembly comprises a trigger stop, engageable against the member. Upon disengagement of the member and the trigger stop, the override assembly forces the frame latch to the retracted position.

The trigger stop inhibits the overriding assembly when the door is in the closed position, thereby allowing the frame latch to project into engagement with the door latch. In one preferred embodiment, each door latch assembly and each frame latch assembly comprise a pair of transversely spaced cooperative latches. The overriding assembly comprises a coil spring with an intermediate U-shaped portion which rotatably biases the member which is one embodiment is a drive arm. The drive arm is engageable with a trigger stop to inhibit the overriding assembly.

A multi-point exit device assembly releasably secures a door to a door frame. A primary latch assembly comprises a projectable door latch located on a secured side of the door. A primary frame assembly is engageable by the door latch. A retraction assembly disengages the door latch from the frame assembly and comprises a set of first cams. Two auxiliary latch assemblies, one located above and one located below the primary latch assembly are mounted adjacent the vertical edge of the door. The auxiliary latch assemblies each comprises a projectable auxiliary latch and a second follower. Two auxiliary frame assemblies are each engageable by an auxiliary latch.

An electric dogging mechanism can be used with an exit device having a latch operatively connected to a push bar mechanism comprises a base plate. The push bar mechanism is mounted to a base plate and operates a latch with an extended latch position and a retracted latch position for the exit device. A holding sub-assembly is attached to the base plate for holding the push bar mechanism in a depressed position and thereby holding the latch in the retracted position. The holding sub-assembly comprises a solenoid plunger connected to the push bar mechanism and a solenoid for holding the push bar mechanism in a depressed position. The push bar is elongated and the plunger and push bar generally longitudinally align.

An electromechanical assembly is adapted for incorporation with an exit device having a latch and a push bar mechanism operatively connected to the latch for moving the latch into a retracted position when depressed. An electromechanical assembly comprises a solenoid plunger movable independently from the push bar mechanism and operatively connected to the latch the plunger upon power being supplied to the solenoid moves the latch into a retracted position without depressing the push bar. The latch can be retracted independently by the push bar assembly and the electromechanical assembly. The electromechanical assembly is located in a housing for the exit device.

### BRIEF DESCRIPTION OF THE DRAWINGS

FIG. 1 is a perspective view, portions removed, of an exit device as mounted to a door and latched to a door frame on the secured side of the door;

FIG. 2 is an exterior side elevational view of the opposite side of the door and door frame of FIG. 1;

FIG. 3 is an enlarged sectional view of a portion of the exit device door and door frame of FIG. 1 taken from the side of FIG. 2;

FIG. 4 is a fragmentary enlarged sectional view of the exit device of FIG. 1 in a latched mode;

FIG. 5 is a fragmentary interior sectional view of the exit device of FIG. 4 illustrated in a released mode;

FIG. 6 is an enlarged sectional view of the exit device of FIG. 4 as installed to a door latch and a door frame;

FIG. 7 is a side view, portions removed and portions broken away, of the exit device of FIG. 1;

FIG. 8 is a sectional view taken along the line 8-8 of FIG. 7;

FIG. 9 is a fragmentary sectional view taken along the line 9-9 of FIG. 7;

FIG. 10A is a perspective view, portions removed, of the exit device and door latch assembly illustrating the latched mode thereof;

FIG. 10B is a perspective view, portions removed, of an exit device and latch assembly of FIG. 10A illustrating the exit device in a release mode;

FIG. 11A is a rear perspective view, portions removed, of the exit device and latching mechanism for the exit device of FIG. 1;

FIG. 11B is a rear elevational view, portions removed, of the exit device and latching mechanism for the exit device of FIG. 1;

FIG. 11C is a front elevational view, portions removed, of the exit device and latching assembly for the exit device of FIG. 1;

FIG. 12 is a rear perspective view, portions removed, of the exit device and latching assembly of FIG. 1;

FIG. 13 is an enlarged fragmentary rear view of the exit device and latching assembly of FIG. 12;

FIG. 14 is a perspective view, portions removed, of the exit device, latching mechanism and the latch assembly of FIG. 1 as installed on a portion of a door and a portion of a door frame;

FIG. 15A is an exploded view of a door frame latching assembly employed with the exit device of FIG. 1;

FIG. 15B is a partially assembled perspective view of the door frame latching assembly of FIG. 15A in retracted latch mode;

FIG. 15C is a fully assembled perspective view of a door frame latching assembly of FIG. 15A;

FIG. 15D is an enlarged frontal view of the door frame latching assembly of FIG. 15C with the cover removed;

FIG. 15E is a sectional view of the subassembly of FIG. 15D taken along the line of E-E thereof;

FIG. 15E is a sectional view of the subassembly of FIG. 15D taken along the line F-F thereof;

FIG. 15G is a sectional view of the subassembly of FIG. 15D taken along the line G-G thereof;

FIG. 15H is a partially assembled perspective view of the door frame latching assembly of FIG. 15A in a projected latch mode;

FIG. 16A is a sectional view of the door frame latching assembly of FIG. 15A together with portions of a door frame, a door, and the door latching assembly with the door illustrated in a pre-closing position;

FIG. 16B is a sectional view of the frame latching assembly of FIG. 16A and the portions of the door frame, door and door latching assemblies of FIG. 16A with the door illustrated in a subsequent closing position just prior to closing of the door;

FIG. 16C is a sectional view of the frame latching assembly of FIG. 16A and the portions of the door frame, door and door latching assemblies of FIG. 16A with the door in the closed position.

FIG. 17A is a perspective view, portions removed, of an alternative latching assembly which can be employed for the exit device of FIG. 1;

FIG. 17B is a perspective view of the latching assembly of FIG. 17A;

FIG. 18 is a perspective view, portions removed, illustrating a solenoid operating mechanism which can be incorporated into the exit device of FIG. 1;

FIG. 19 is a perspective view, portions removed, of an electromechanical assembly which may be incorporated into the exit device door frame and door of FIG. 1 as installed on portions of a door and a door frame; and

FIG. 20 is a side elevational view, portions removed, of the electromechanical assembly with the exit device as illustrated in FIG. 19.

### DETAILED DESCRIPTION

With reference to the drawings wherein like numerals represent like parts throughout the several figures, an exit device which is adapted for heavy duty high security applications is generally designated by the numeral 10. The exit device 10 is installed on an exit door 12 at the secured side 14 and latches to a door frame 16. The exterior side 18 of the door 12 may include a key operated latch 19.

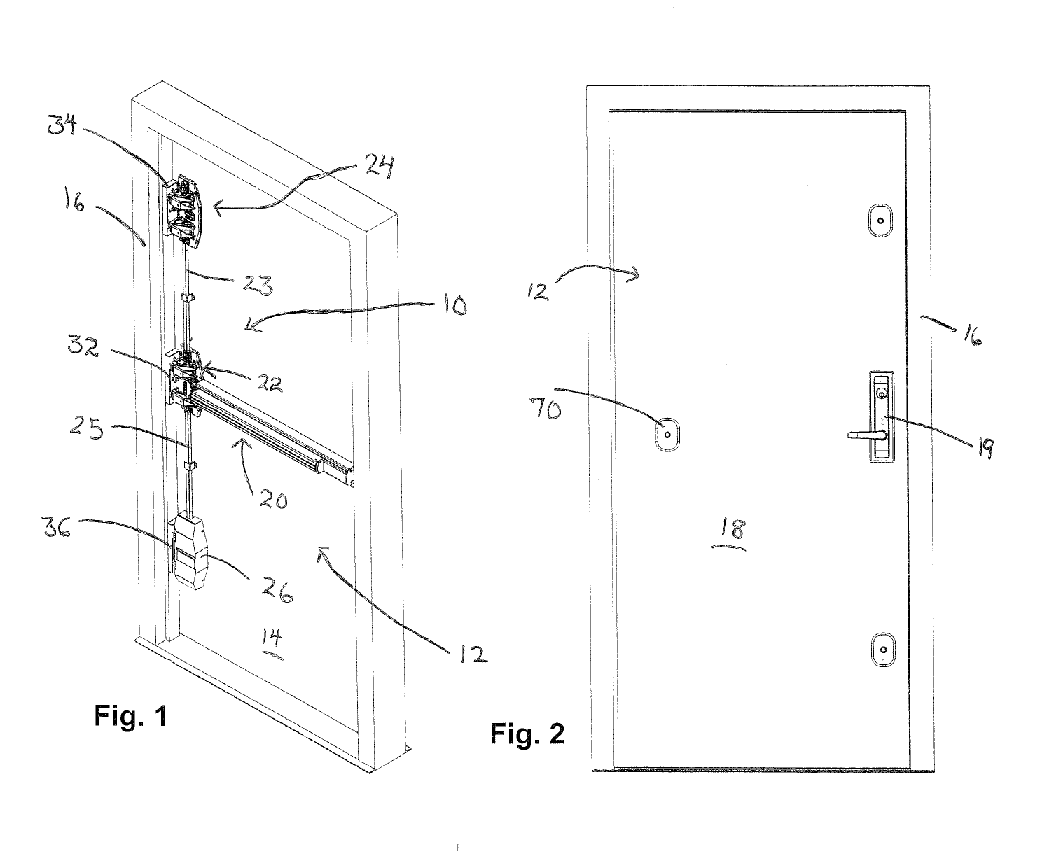

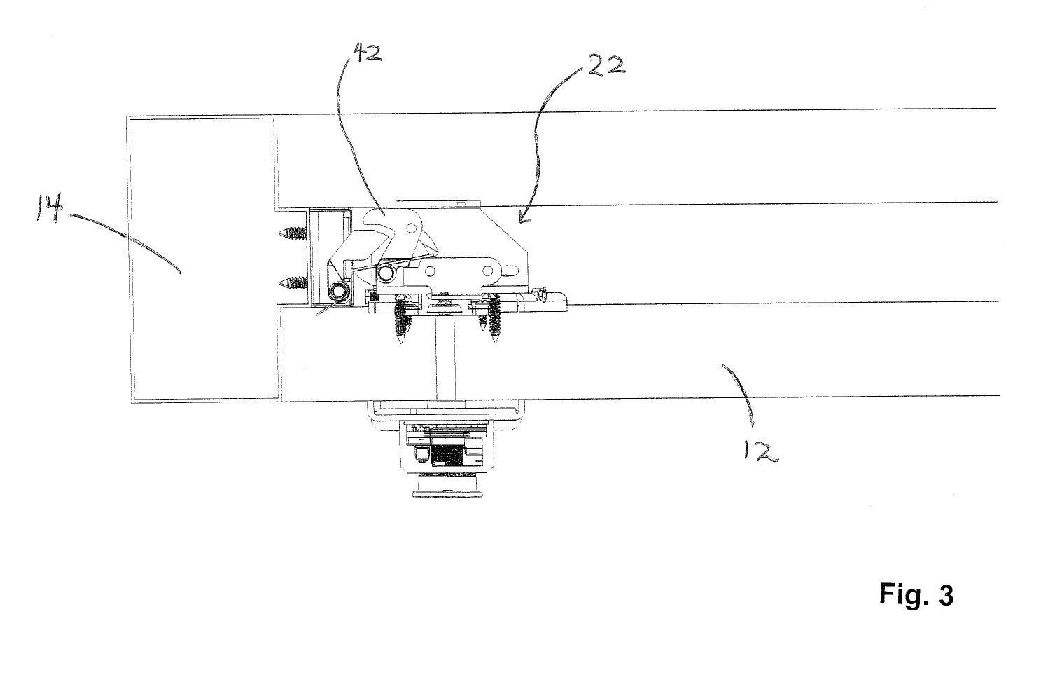

In general, the exit device 10 comprises a panic bar assembly 20 which operates a principal door latching assembly 22. The latching assembly 22 optionally, via a connecting rod 23, functionally connects with an auxiliary upper latching assembly 24 and via a connecting rod 25 with an auxiliary lower latching assembly 26. Each of the door latching assemblies 22, 24 and 26 latch with a corresponding frame latching assembly 32, 34 and 36, respectively, each of which is mounted to the inner portion of the door frame 16 adjacent the edge of the door when the door is in the closed position illustrated in FIG. 1. Door latching assemblies 24 and 26 are optional and the panic bar and latching assemblies 20 and 22 may assume various alternative forms, as will be further described herein. The door frame latching assemblies 32, 34 and 36 likewise may assume various forms, each of which includes projecting latch members which extend for interengagement by the corresponding projecting latch members on the latching assemblies.

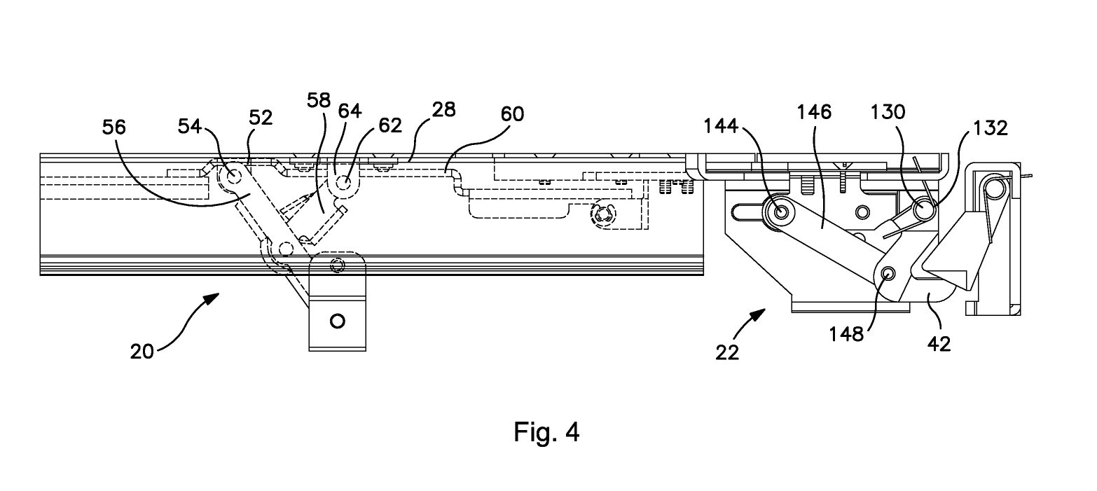

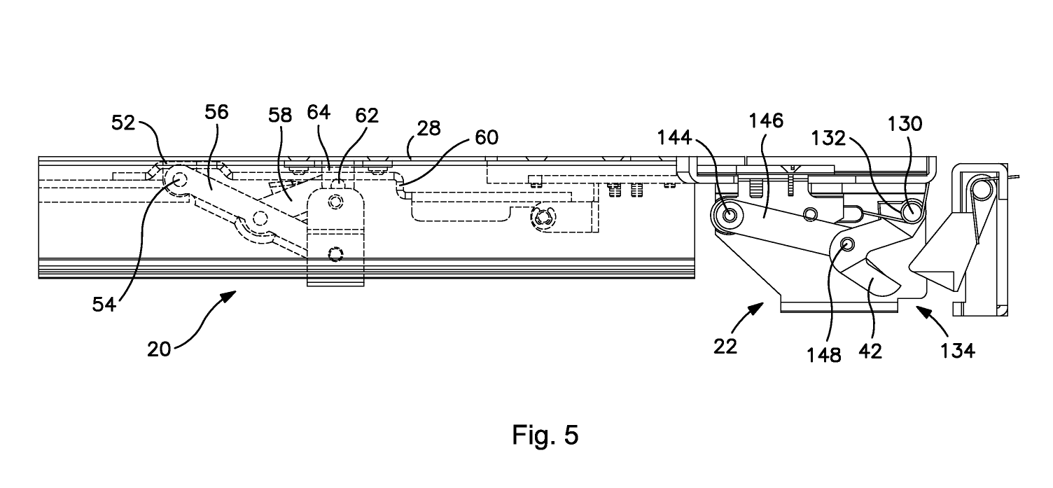

The panic bar assembly 20 includes an elongated base 28 (FIGS. 4, 5) which mounts to the door and functionally connects with the dual latching assembly 22 which is mounted to the door adjacent the open edge thereof. The base 28 has opposed elongated sides and an open end and top. An elongated bar 40 is mounted to the top of the base and is typically biased so that it is in an outer position spaced from the door. Upon depression of the bar 40, a longitudinally slidable assembly causes a longitudinal translation of a slide member 60 which forces a pair of bifurcated claw-like latches 42 from the protracted closed latched position of FIG. 4 to the retracted released position of FIG. 5.

A generally U-shaped bracket 52 is disposed in fixed relationship to the base 28 (and the door). The bracket 52 mounts a pin 54 with a transfer link 56 pivotally connected to an actuator 58 at an intermediate position thereof. A second end of the actuator 58 connects via a pin 62 to an upright bracket 64 of the slide member 60. The upper end of the transfer link 56 is pivotally connected to a panic bar mounting bracket 66. The panic bar 40 is mounted over the bar mounting bracket 66. When the bar 40 is depressed downwardly, the actuator 58 is forced to pivot downwardly thereby resulting in the slide member 60 moving to the left in FIG. 5. The opposed end of the slide member connects and operates with the dual latching assembly 22.

The panic bar assembly 20 is preferably mounted to the door via fasteners which extend through openings in the base 28. In addition, an anchor plate 70 connects with a standoff 72 extending through a bore (FIG. 9) in the door. The standoff 72 has an internal threaded surface which receives and mates with a threaded fastener 74 extending through the base. The fastener draws in the standoff and anchor plate 70 so that the anchor plate engages the exit side 18 of the door as, for example, illustrated in FIG. 2.

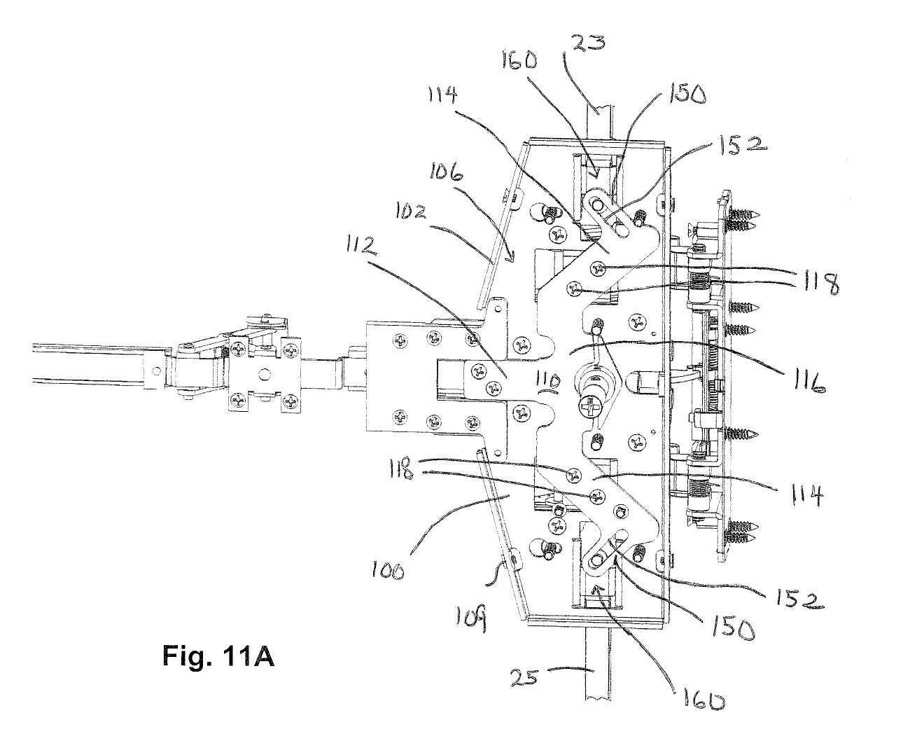

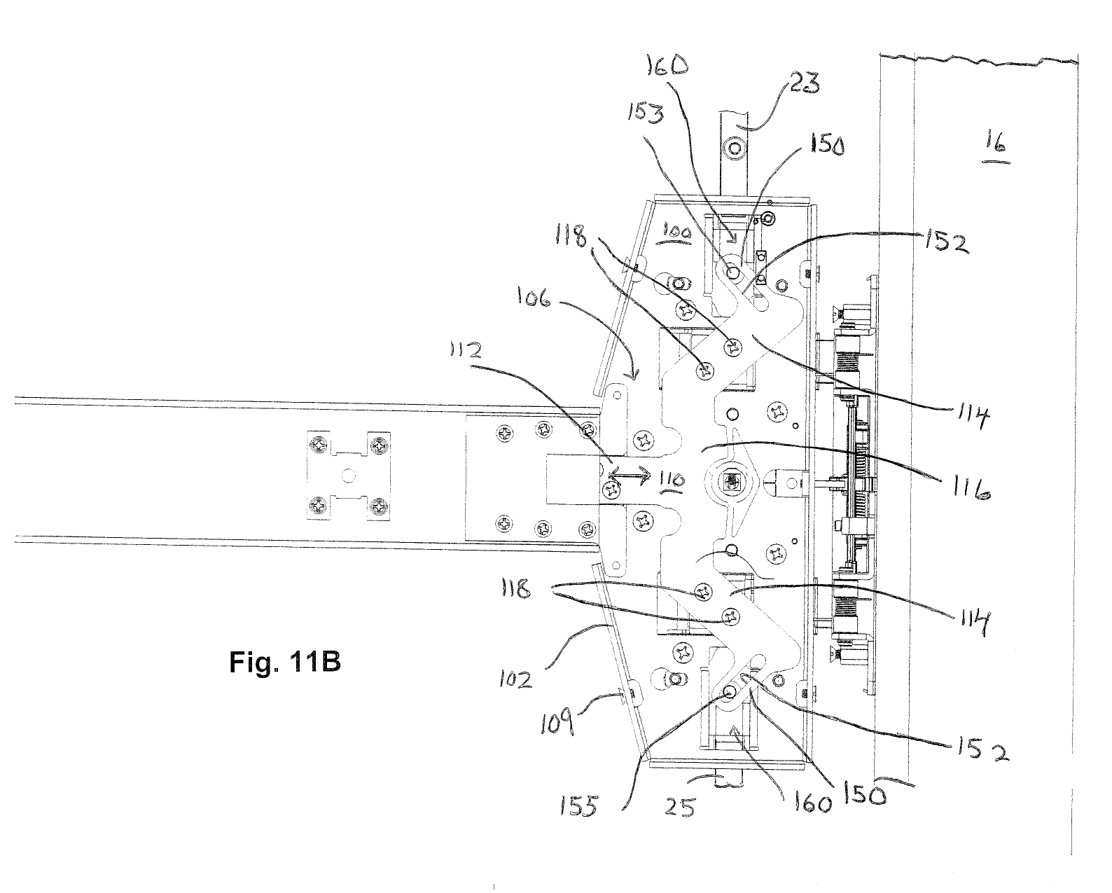

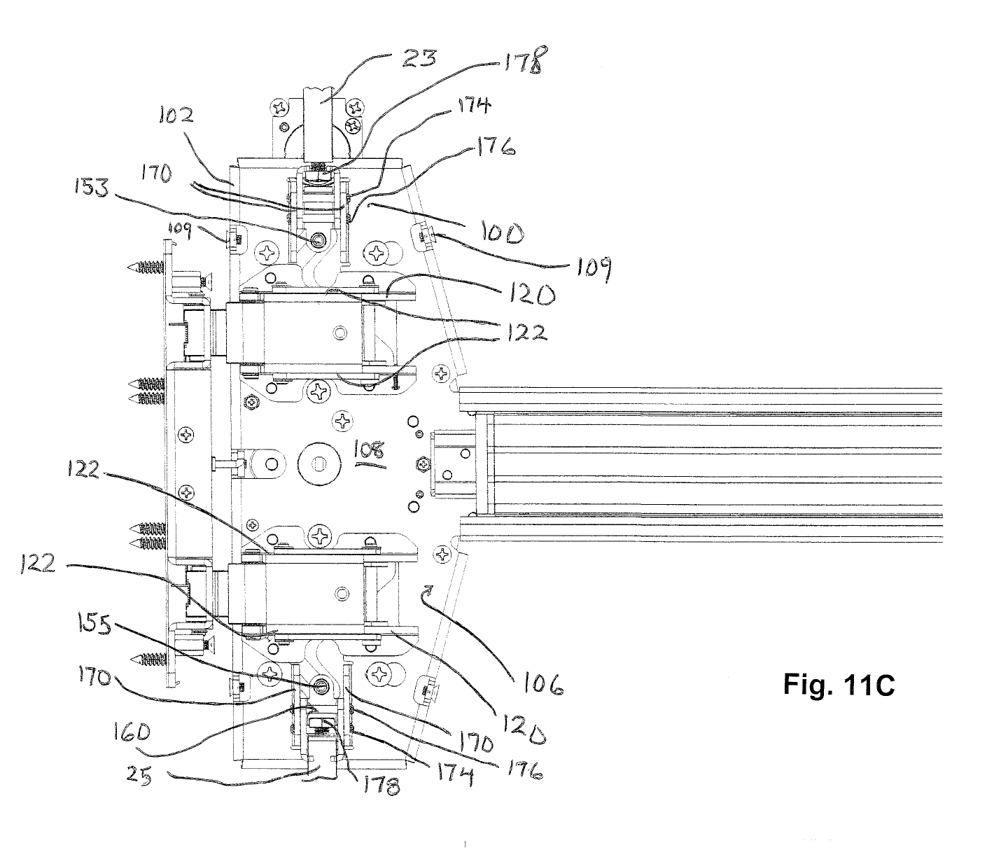

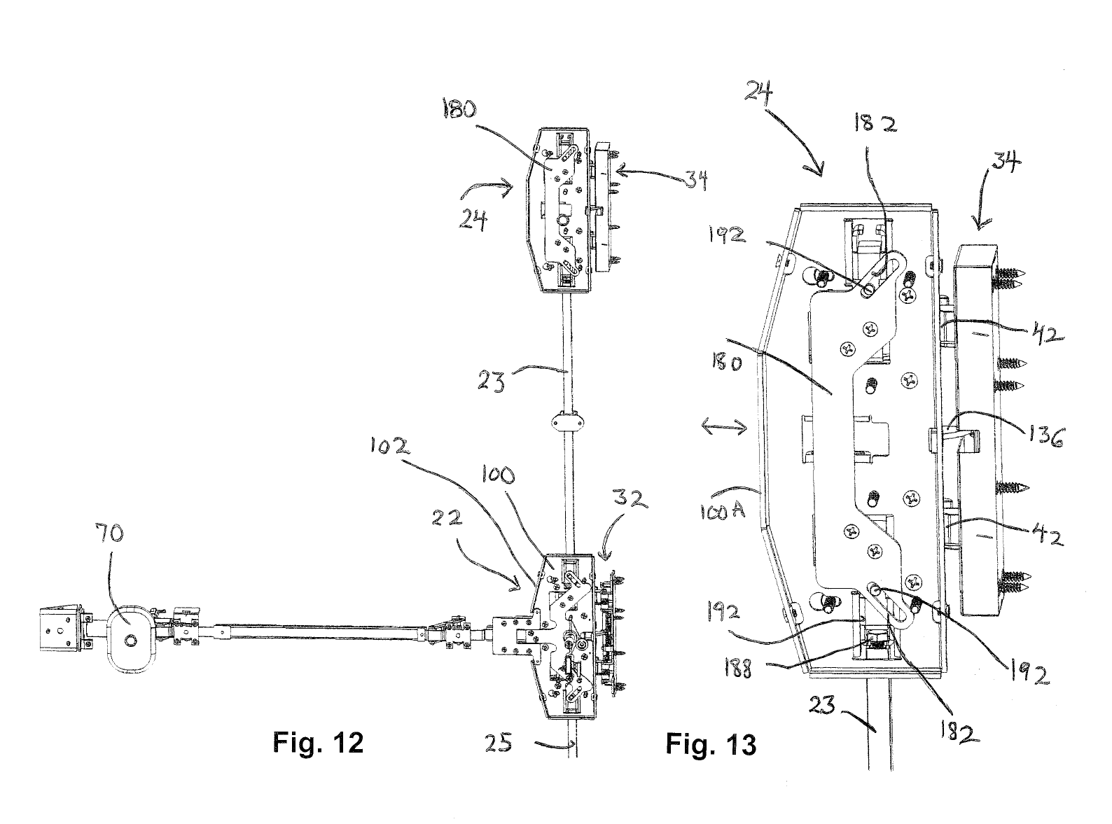

The door latching assembly 22 comprises a platform 100 with a peripheral skirt 102. Upon installation, the peripheral edge of the skirt 102 engages against the secured side 14 of the door. The platform 100 has a rear extension 104 which is received by the forward end of the base 28 and is secured therewith. The underside of the platform 100 forms a recess 106 for a longitudinally reciprocating actuator plate 110. With reference to FIGS. 11A and 11B, the actuator plate 110 includes a central longitudinal connector 112 and a pair of wings 114 which extend at 45° angles to a central transverse cross portion 116 and the longitudinal connector 112. The plate 110 slides longitudinally generally in the direction of the arrows of FIG. 11B.

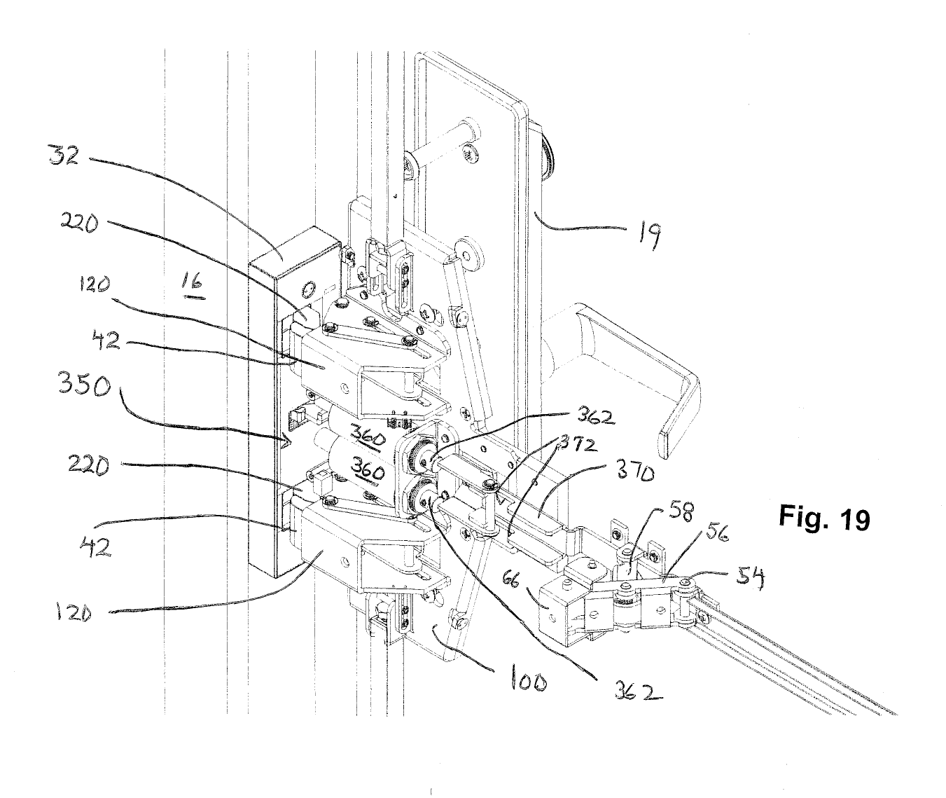

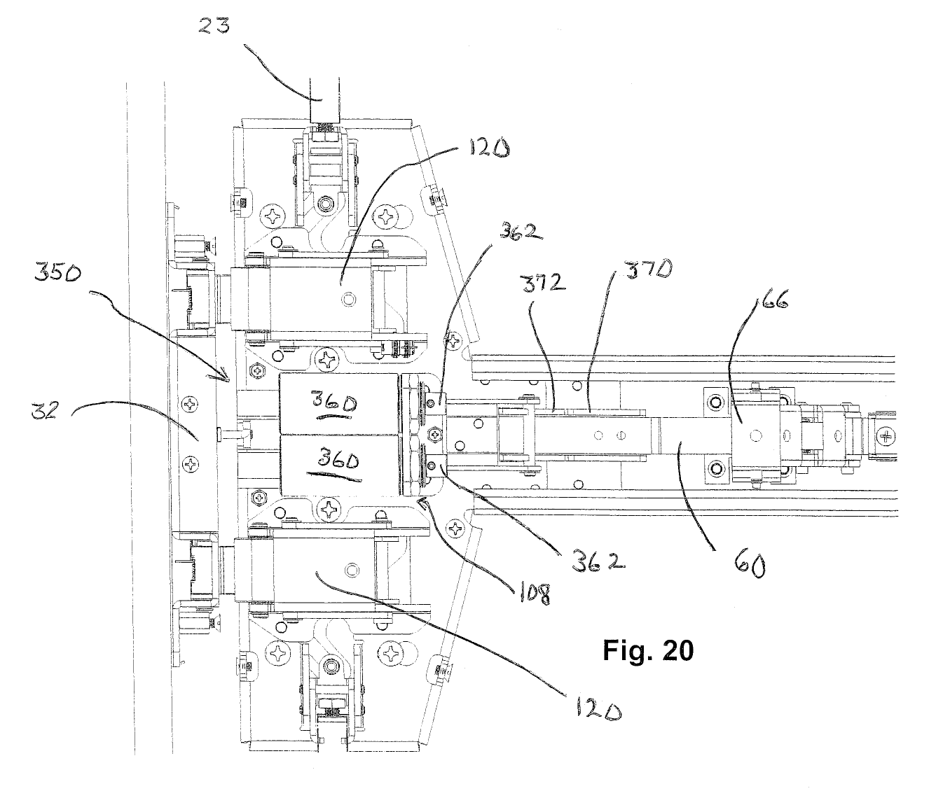

The top side of the platform mounts a pair of substantially transversely spaced identical latch housings 120. Each housing 120 has a pair of transversely spaced upright walls 122. Each wall has a pair of longitudinal collinear slots 124 and 126 and an arcuate upper cam slot 128 which align with opposed substantially identical corresponding slots in the opposite walls. The latch 42 is pivotally mounted via a pin 130 which is received in a lower aperture proximate the forward edge of the frame. The latch has a limit shoulder 44 adjacent the pin mounting position. The latch preferably has a bifurcated claw-like form with a central recess 43. A coil spring 132 is received in a lower recess of the latch and wraps around the pin for biasing the latch to a generally forward position which projects through an upper frontal opening 134 in the housing 120. There is a significant central platform area 108 between the latch housings 120. The area 108 can be used to accommodate additional features as illustrated in FIGS. 19-20.

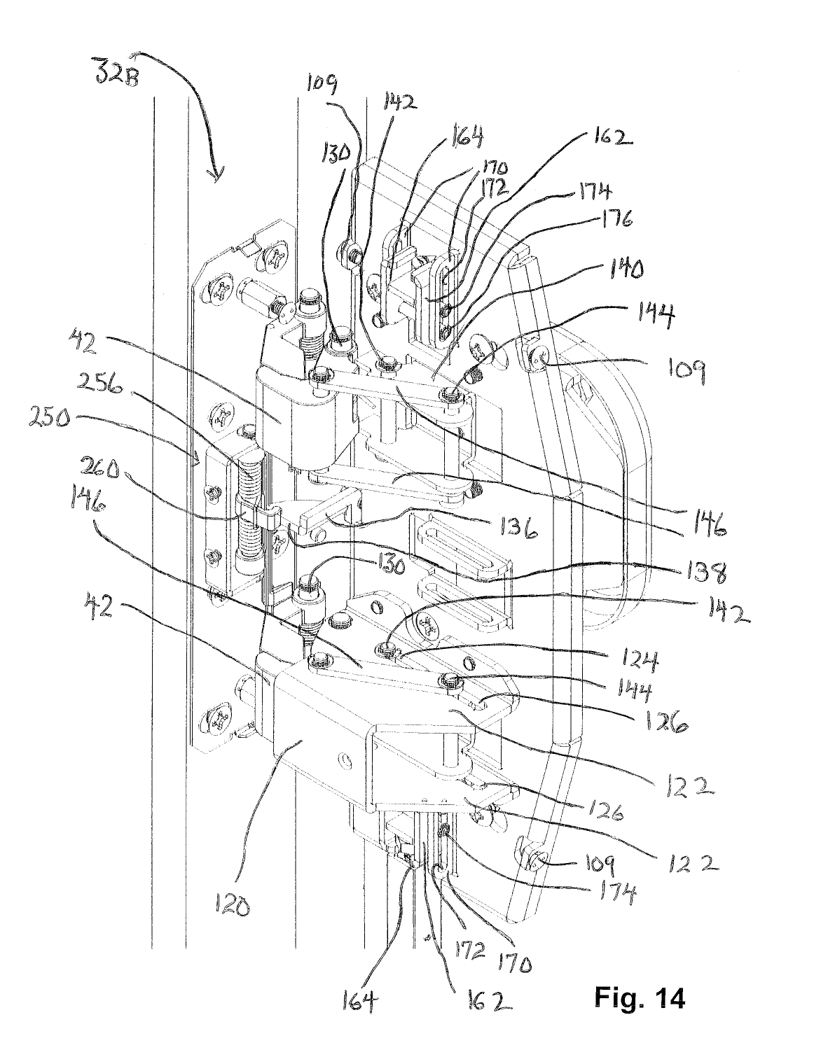

With reference to FIG. 14, a trigger 136, which has a forwardly projecting surface 138, is mounted to a frontal central portion of the platform 100. A cover mounts over the platform 100 and is secured by fasteners 109. The cover has two transversely spaced openings for the latches 42 and a central smaller frontal opening for the trigger 136. If required, the cover may also have side openings to accommodate actuating rods 23 or 25.

An inverted U-shaped carrier 140 is nested between the housing walls 122 and is connected to each housing 120 through each wall via a pair of pins 142 and 144, one received in the rear slot and one received in the forward slot. The forward end of the carrier has an upper shoulder 141 which is engaged by the latch shoulder 44 to rigidly reinforce the projected position of the door latch 42. The rear pin 144 also exteriorly mounts a pair of spaced retraction arms 146 which are pivotally connected to the pin. The opposed end of each retraction arm 146 is pivotally mounted via a pin 148 which extends through a transverse bore in the bifurcated portions of the latch 42. The pin 148 follows the arcuate cam slot 128 in the walls of the opposed side.

The underside of the carrier is fastened to each wing 114 of the actuator plate 110 by screws 118. When the actuator plate is rearwardly retracted, the carrier 140 rearwardly moves and the retraction arms 146 each pull the latch in a coordinated action so that each latch 42 pivots and slides both rearwardly and downwardly.

It will be appreciated that there is an identical structure at the opposing sides of the platform so that each latching assembly 22 essentially provides for two transversely spaced controlled projectable and retractable latches 42.

With reference to FIGS. 11A-11C, the actuator plate 110 for the central principal latching assembly 22 includes a pair of extensions 150 which project perpendicularly from each of the wings 114. The extensions contain a 45° diagonal slot 152 and function as a guide or cam surface for movement of a pin 153 or 155 in the slot. The pins 153 and 155 are fixed to and radially extend from adjustable connector modules 160. The connector modules 160 are transversely slidable for displacing the rods 23 and 25, respectively, to thereby actuate the upper and lower auxiliary latching assemblies 24 and 26, respectively.

The top of the platform 100 includes two sets of transversely spaced, upstanding parallel flanges 170. Each set of flanges forms a receiver. Each of the flanges has a transverse slot 172. Each connector module 160 includes a carrier 162 with a restricted nose-end 164 defining a reduced opening. The carrier 162 is mounted to the flanges by a pair of pins 174 and 176 which slide along the slots 72 so that the carrier moves transversely relative to the upstanding flanges 170.

The end of the actuating rod 23 or 25 is connected to the carrier by means of an adjustable hex head screw 178. The hex head is received in the carrier 162. The shank threads into the end of the rod with the threaded shank of the screw extending through the restricted nose-end 164 while the hex head is limited or captured by the nose-end 164. Thus, movement of each carrier 162 causes the associated rod to transversely move. The proximal end of the carrier mounts the pins 153 or 155. The nose-end 164 defines the outer limit for movement of the rod. The inner movement is defined by the innermost position of the inner pin and the end of slot 172 subject to the threaded adjustment of screw 178.

As the actuator track plate 110 is retracted, the pins 153 and 155 traverse the corresponding diagonal slots 152 and cause the actuating rods 23 and 25 to reciprocate inwardly and outwardly to thereby retract a corresponding actuator plate of the upper and lower latching assemblies 24 and 26, as will be described below.

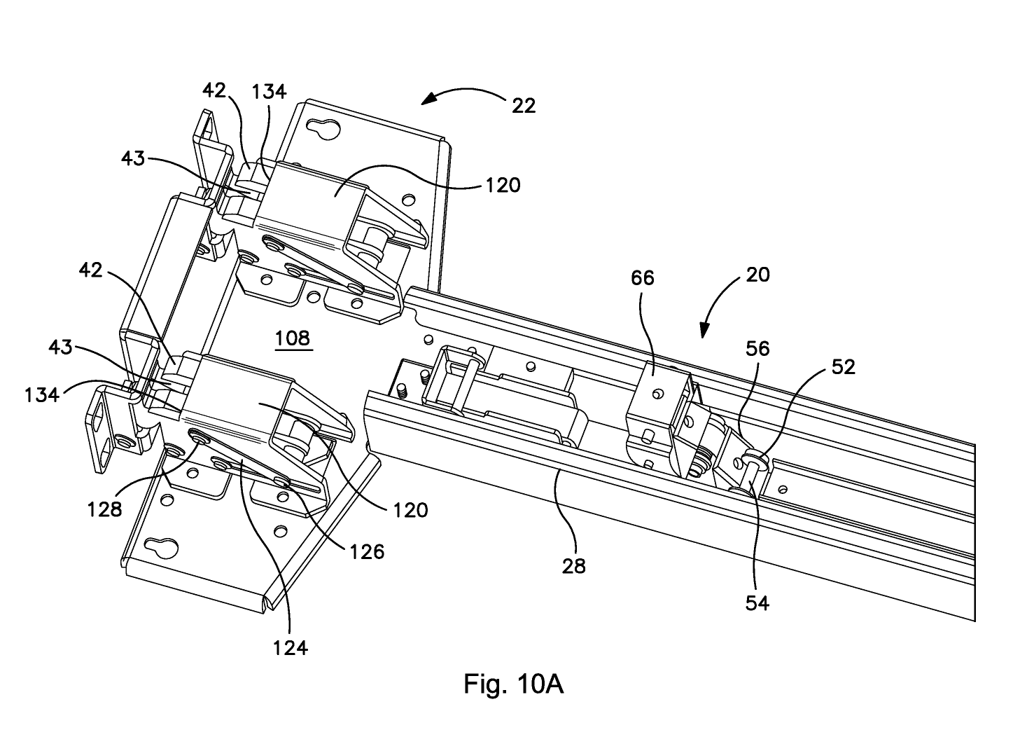

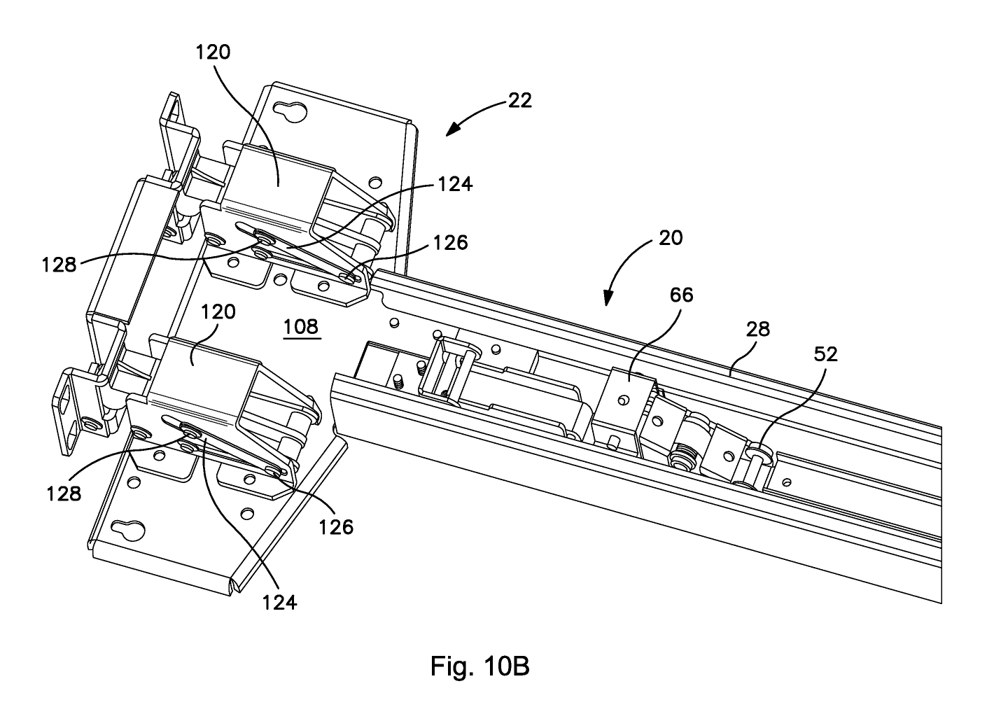

It will be appreciated that for installations wherein the auxiliary latching assemblies 24 and 26 are not required, the upstanding flanges on the platform 100 as well as the connecting assemblies for the rods, are not required, such as, for example, the embodiments illustrated in FIGS. 10A-10B.

Auxiliary latching assemblies 24 and 26 (and any other latching assemblies that may be employed) have substantially the same structure and function as latching assembly 22 except that the latches are not operated by the panic bar, but by a complementary orthogonally driven movement of a corresponding actuator rod 23 or 25.

A representative auxiliary latching assembly is illustrated in FIG. 13. The principal difference compared to latching member 22 is the structure of the actuating plate 180. The plate 180 has a pair of diagonal slots 182 (45° relative to a longitudinal axis) which functions in a complementary manner as compared to the corresponding plate 110 and slots 152, as previously described for central primary latching assembly 22. Slots 182 essentially function as followers. The upper end of rod 23 includes an adjustable hex head screw received in a carrier 190 which carries a pin 192. The pin 192 essentially functions as a cam. Movement of the carrier due to transverse displacement of the actuating rod 23 drives the pin 192 to slide along the slot 182 and therefore forces the actuating plate 180 to move longitudinally in the direction of the FIG. 13 arrow.

The actuating plate 180 is fastened to the corresponding carriers 140 for the latches 42 by means of screws 184. The top of the corresponding platform 100A includes a pair of latch housings 120 and projectable latches 42 which are substantially the same structure and are retracted and extended in the same fashion as previously described for the corresponding structures for latch mechanism 22. A trigger 136 is also provided. Thus it will be appreciated that depressing the panic bar 40 which actuates latching assembly 22 correspondingly also results in a displacement of a connecting actuating rod 23 and/or 25 which functions to also retract the latches of each of the corresponding auxiliary latching assemblies 24 and/or 26.

It should be appreciated that additional auxiliary latching assemblies could be provided and operatively connected via an actuating rod and carrier assembly driven via an upper pin 192. Multiple additional auxiliary latching assemblies and actuating rods (which operatively connect with auxiliary latching assemblies 24 and/or 25 locking assemblies) could be employed to provide multiple latching locations.

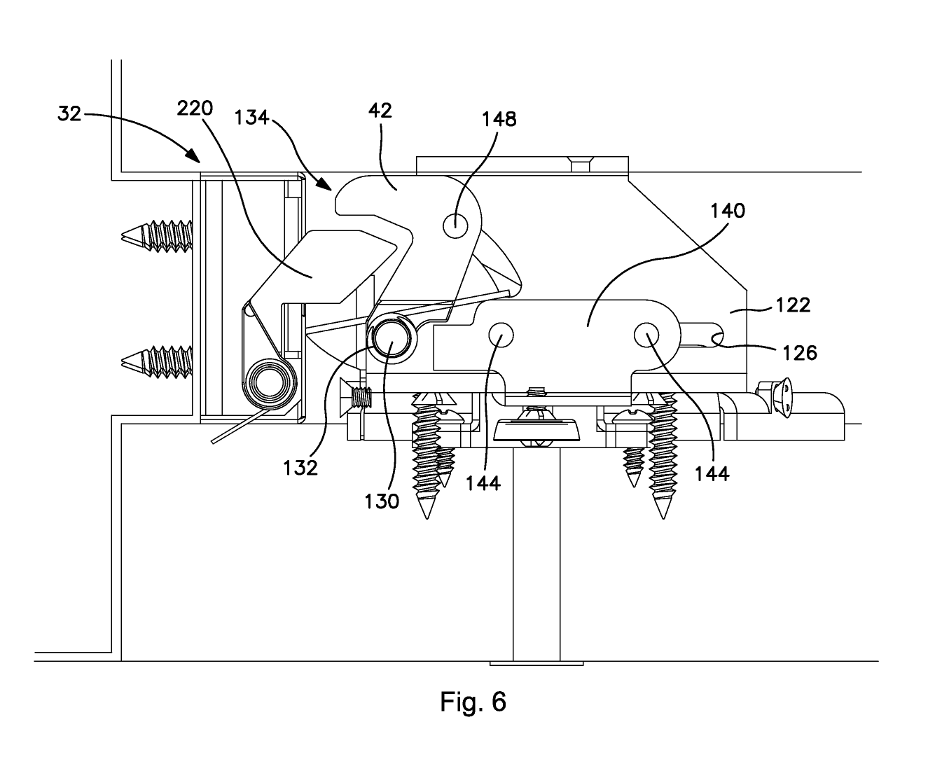

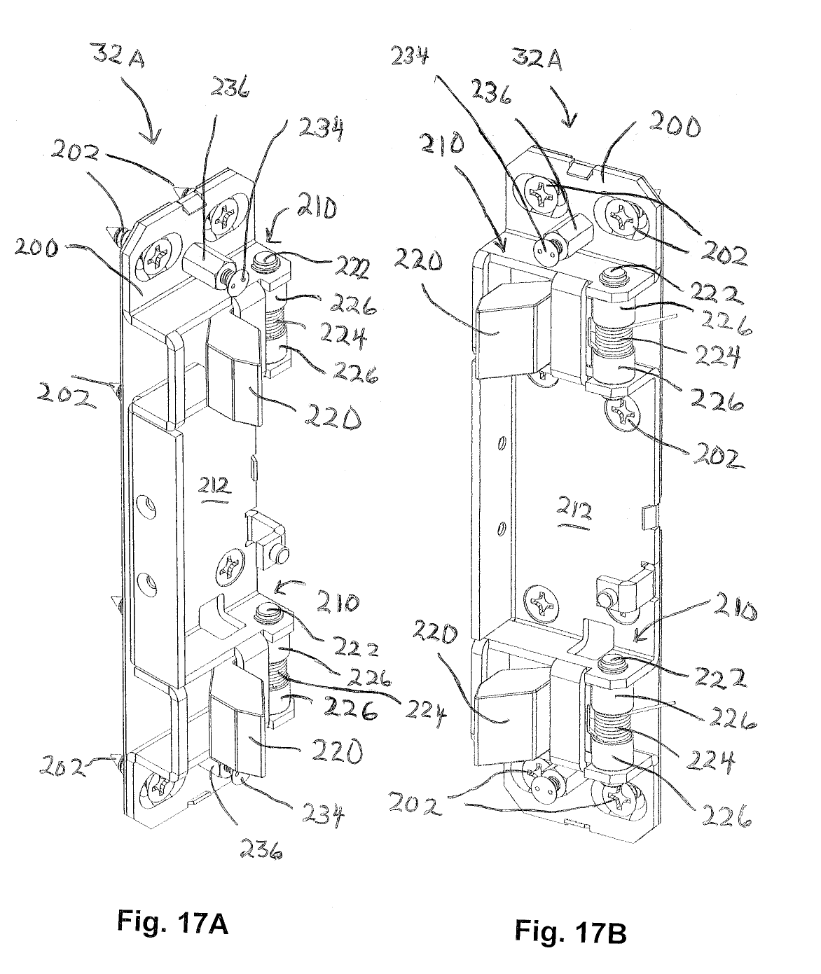

With reference to FIGS. 17A and 17B, door frame latch assembly 32A includes, in one embodiment, a multi-walled support frame 200 which is secured to the edge of the door frame 16 opposite a door latching assembly in surface-to-surface engagement by screws 202 secured through openings of the frame. The door frame latch assembly 32A comprises a pair of transversely spaced yokes 210 which include upstanding brackets. A projectable latch 220 has a configuration generally complementary to the claw-like configuration of the door latches 42. One end of the frame latch 220 includes a throughbore which receives a mounting pin 222 extending through opposed sides of the yoke brackets. A torsion spring 224 wraps around a central portion of the pin 222 between a pair of spacers 226. Spring 24 bears against each latch member 220 to outwardly bias the latch in a projected position from the yokes so that the door frame latch 220 and the door latch 42 both project to interengage and essentially latch the door, such as, for example, illustrated in FIG. 6.

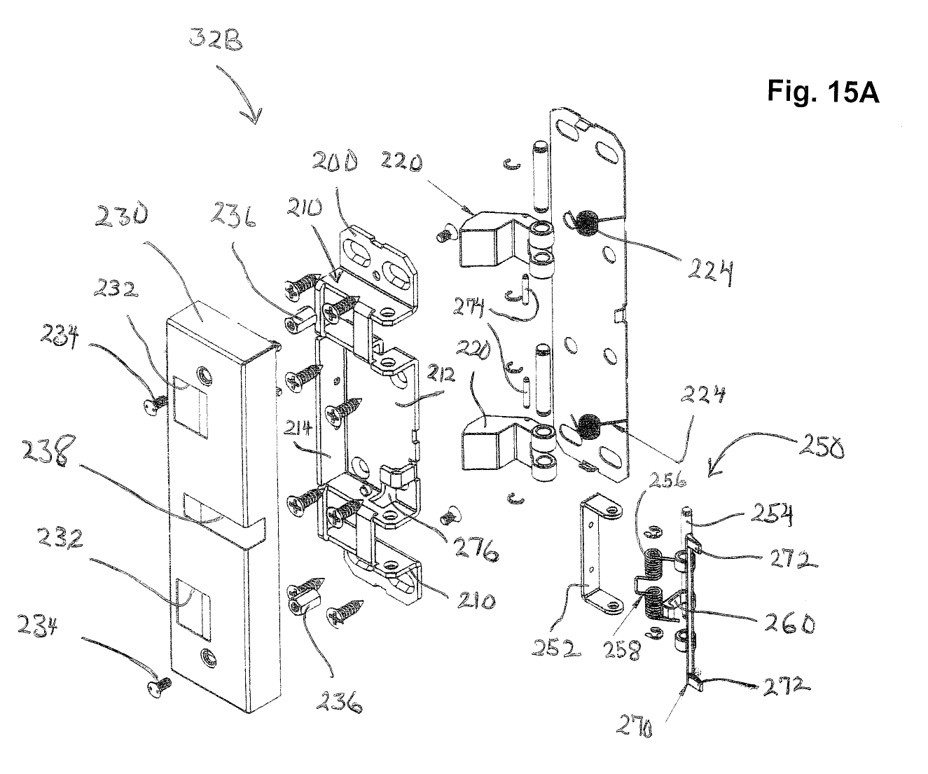

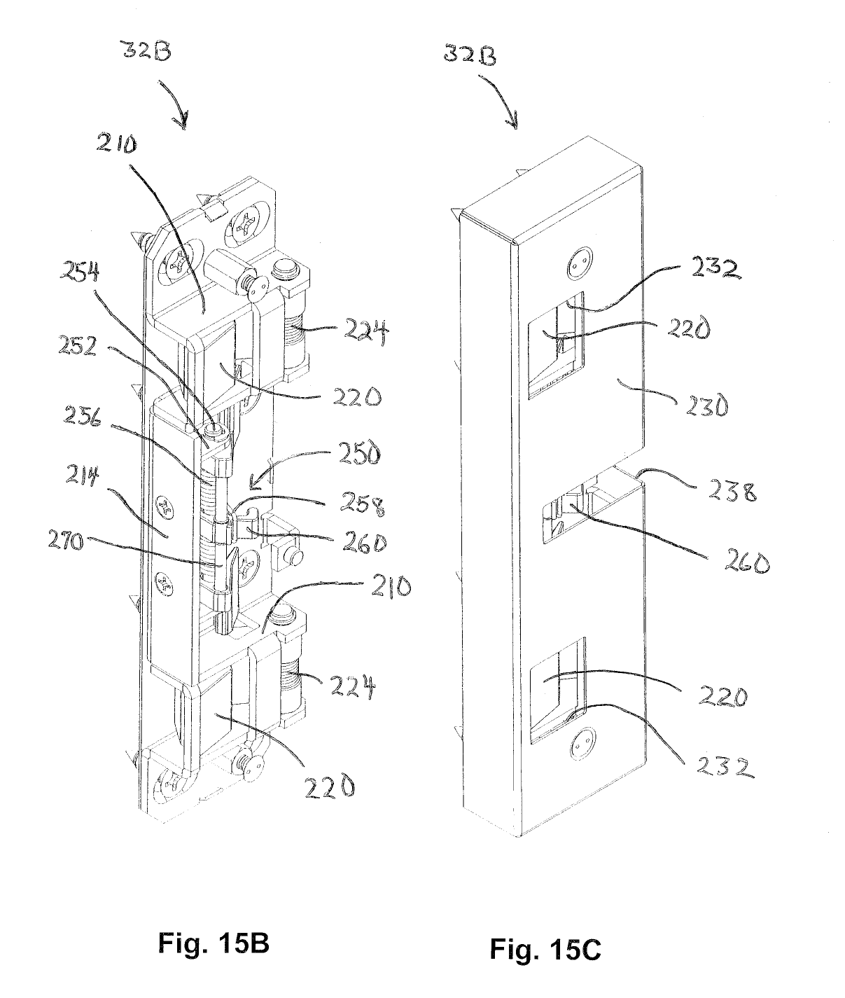

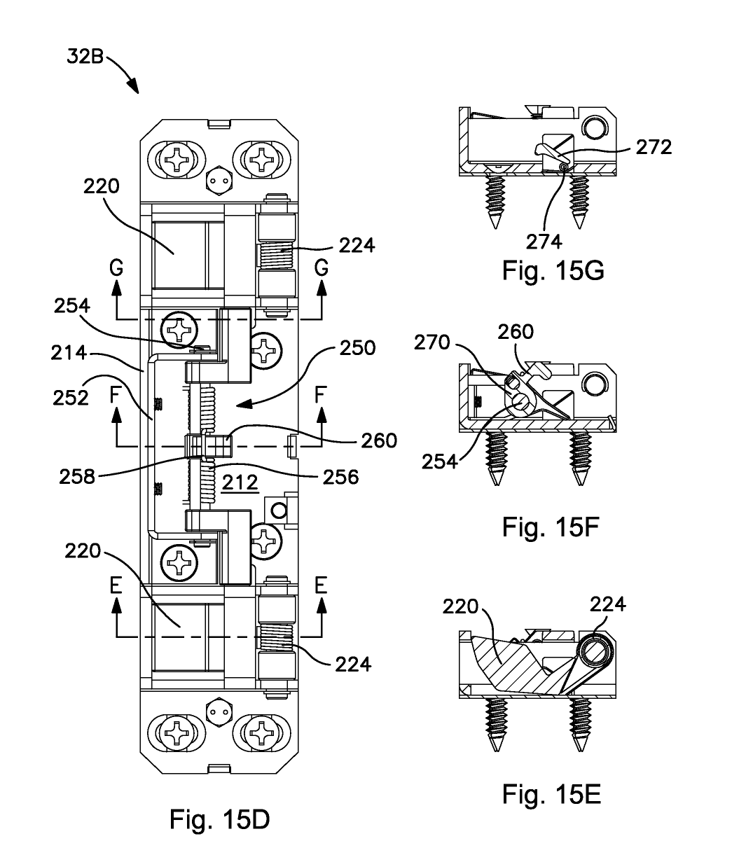

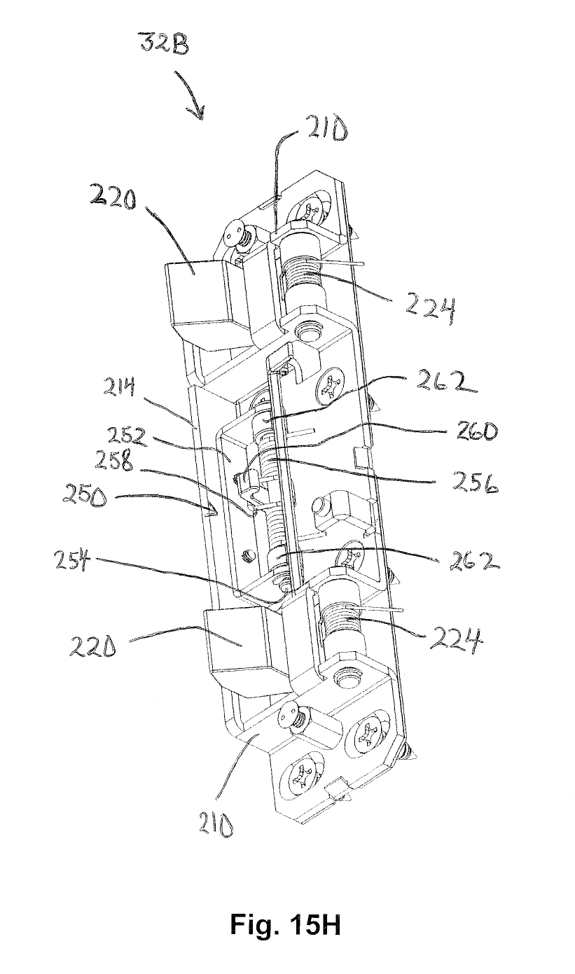

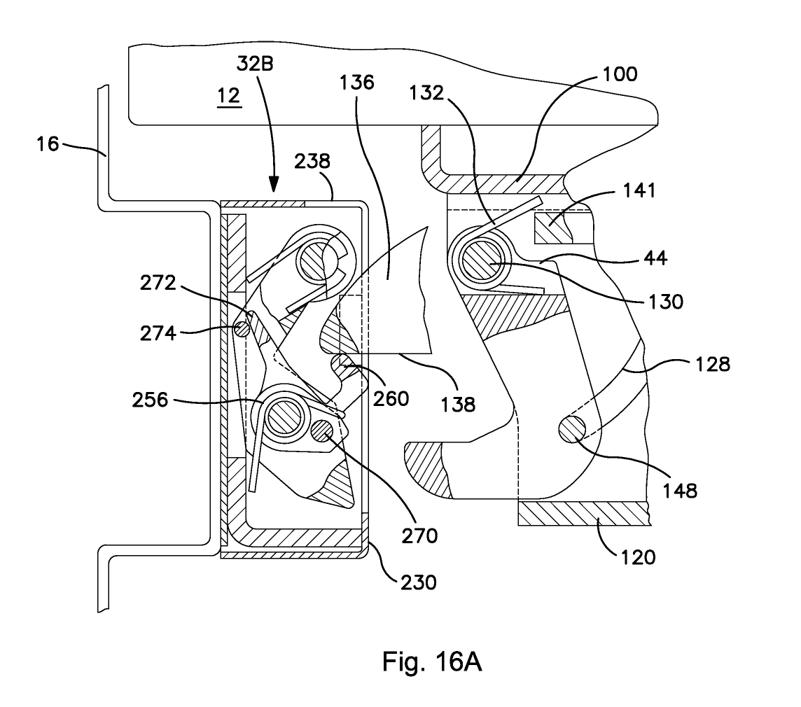

A cover 230 (FIG. 15A) with a pair of openings 232 for each latch member is mounted over the support frame 200. The cover is secured by a pair of screws 234 which thread into a spacer boss 236.

It will be appreciated that any attempt to separate the door from the latching engagement is generally distributed through or slightly offset from the latch pin 130. Consequently, the cooperative latch mechanisms do not exhibit the wedge-type separation susceptibility as is common in many conventional-type latching mechanisms. When the door latch 42 is retracted, the door is free to pivot relative to the door frame latch and the door can thus be opened.

With reference to FIGS. 14 and 15A-15H, for some preferred embodiments, the door frame latch assembly 32B includes an override assembly 250 which is functionally disposed between the projecting spring biased latches 220 and, upon triggering, functions to apply an override force for returning the latches 220 to a retracted position within the cover 230. In this regard, the override assembly 250 has a greater spring force than that provided by the torsion springs 224 which function to normally project the latches to the projected position. The override assembly 250 is positioned in the central frame cradle 212 between the yokes 210.

A U-shaped bracket 252 is attached to a sidewall 214 of the support frame 200. The bracket has a pair of opposed openings which receive a pin 254. A torsion spring 256 is configured to form a medial catch 258 is mounted about the rod and engages the back of a drive arm 260 to exert a pivotal biasing force on the drive arm 260. Spacers 262 may be placed at each of the ends of the springs to generally center the spring 256 with the bracket 252.

An actuator bar 270 fixed with the drive arm 260 has a pair of opposed flappers 272 which engage pins 274 projecting from the side of the latch members 220. A stop 276 projects into the recess to provide a limit for the flappers 272. When the drive arm 260 is activated by removing the blocking element from the latching assembly 22, the drive arm is free to project under the force of the spring 256 and moves the actuating member to pivotally move the pins 274, thereby causing the latch members 220 to overcome the bias of the springs 224 and retract into the housing. The drive arm 260 is accessible via a central slot 238 in the cover 230. The cover 230 is mounted over the door frame latch assembly base support frame. The slot 238 is positioned and dimensioned to receive and be engaged by the trigger 136 mounted with the door (see FIG. 14). Upon release of the actuator arm 260, the force of the spring 256 outwardly retracts the latches 220 into the cover as illustrated in FIGS. 15B and 15C.

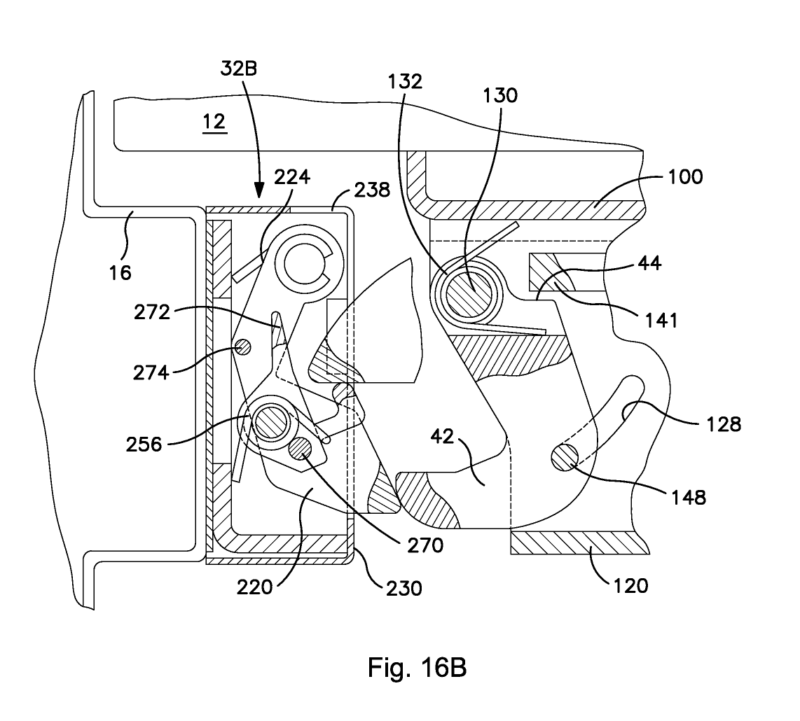

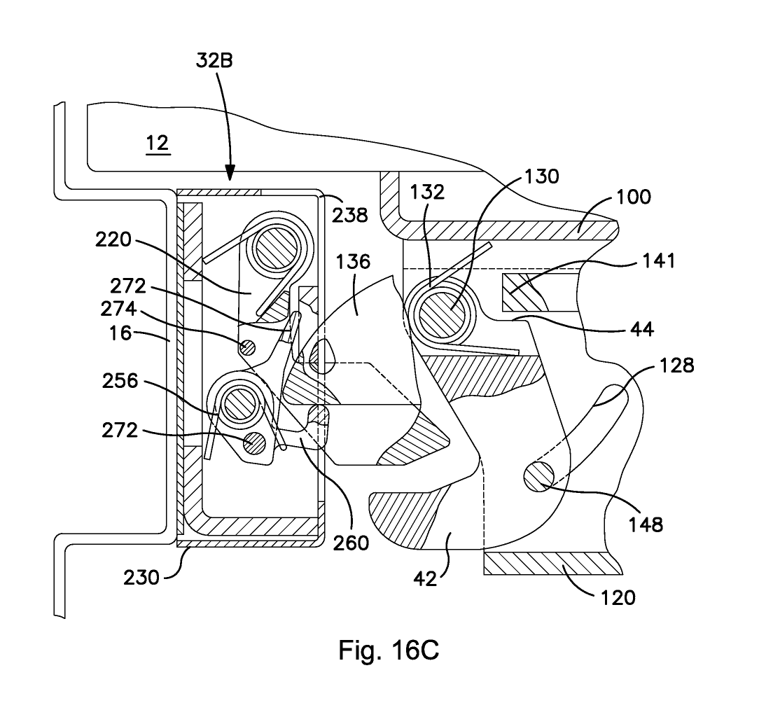

With reference to FIGS. 16A-16C, the actuator bar 270 fixed with the drive arm 260 has a pair of opposed flappers 272 which engage pins 274 projecting from the side of the latches 220. The entire sub-assembly is biased by means of the spring 256 towards pins 274 therefore pushing the latches 220 into a retracted position. The force of spring 256 is stronger than the forces of springs 224 which bias the latches into opposite outward projected positions. Thus, in the retracted position shown in FIG. 16A, when the door is still open and the trigger 136 attached to the door latching assembly has penetrated the slot 238 to a position wherein it just engages the drive arm 260, the latches 220 are still retracted.

FIG. 16B shows a more advanced door position wherein the door is nearly closed and about to be latched. Trigger 136 pushes the drive arm 260 further downwardly (clockwise) releasing the pins 274 from the pressure created by the spring 256, thereby allowing the springs 224 to rotate the latches 220 somewhat (counter-clockwise) out of the housing restricted only by the presence of the door latches 42, which are now fixed in a stable pivot position by the engagement of latch shoulder 44 and carrier shoulder 141.

FIG. 16C shows the door in a theoretically closed position. The fixed door latches 42 are advanced beyond the tips of the latches 220, allowing the springs 224 to complete the clockwise swing of the frame latches into an upright projected position. The door latches 40 and the frame latches 220 have been mutually latched. The override assembly 250 is inhibited in retracting the latches 220 by the engagement of the trigger 136 and the actuator arm 260.

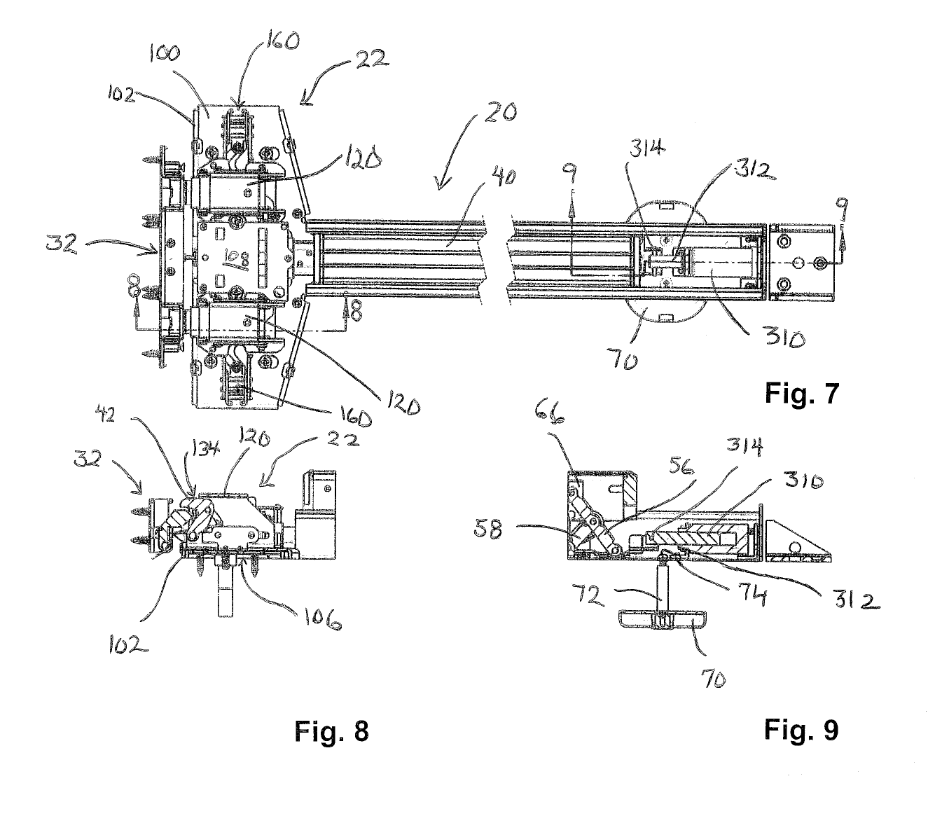

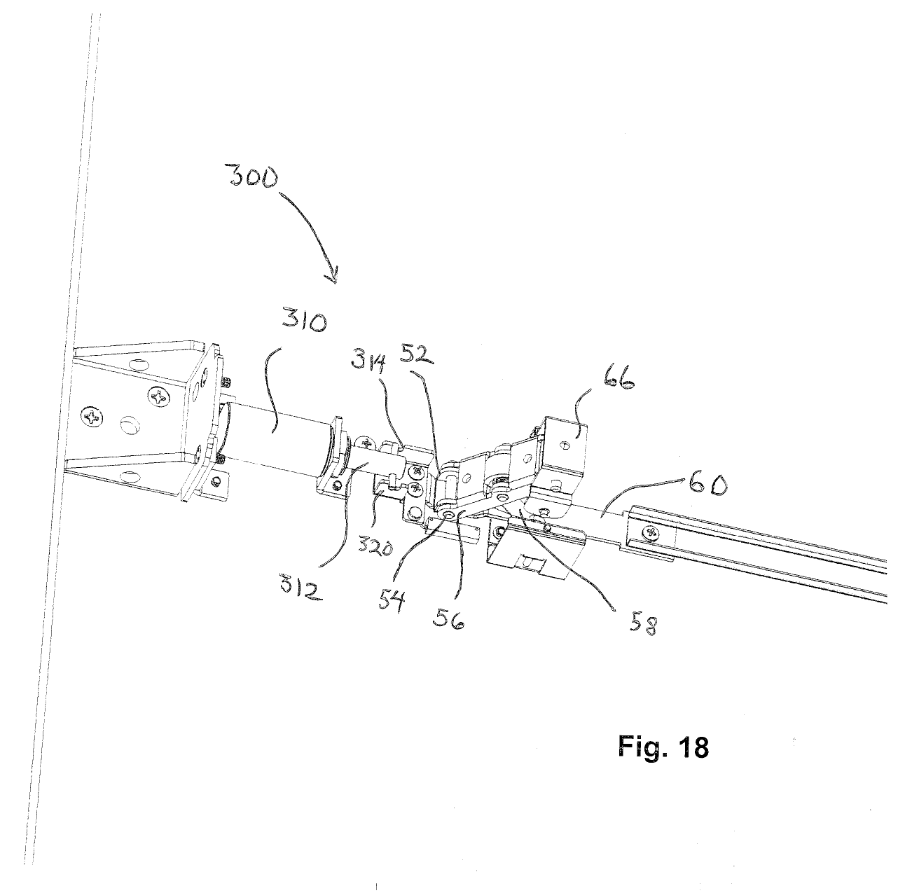

With reference to FIGS. 7, 9 and 18, the position of the panic bar (which is mounted over bracket 66) may also be controlled by an electromechanical assembly 300, such as one that employs a solenoid 310. The solenoid 310 has an actuator arm 312 with a transverse cross-pin 314. A slidable coupler 320 includes a pair of opposed longitudinal slots 322 which receives the cross-pin 314. The coupler 320 connects with slide member 60. The ends of the slot 322 define the range of longitudinal displacement of the coupler. The solenoid 370 may be electrically actuated from a remote location to maintain the panic bar at the depressed (dogged) position once the panic bar is initially depressed. During normal hours, egress through the door does not require actuation of the panic bar to release the latches 42 after the initial depression of the panic bar 40. The solenoid has sufficient power to maintain the depressed panic bar/retracted latch condition. The solenoid 310 may be wired into the overall fire safety system for the building so that in case of a fire, the door will automatically latch.

With reference to FIGS. 19 and 20, another electromechanical override assembly 350 may be employed with one or two solenoids 360 which are mounted to the central area 108 between the two latch housings 120. A slidable bridge 370 connects between the actuator arm 110 and the slide member 60 governed by the panic bar 40. The bridge has opposed longitudinal slots 372. The solenoids each have actuators 362 which engage a slidable coupler 364 having a cross-pin 366 which is received in opposed slots 372. The solenoid actuators 362 bear against the cage 364 to provide an independent override unlatched position for the latches 42 by rearwardly moving along the slots 372. The ends of the slots 372 function as limits for movement of the bridge 370.

The solenoids 360 can be employed to provide for the remote actuation and automatic de-actuation (retraction) of the latches 42 at various times throughout the working day. The panic bar 40 for this assembly is also depressible throughout the implementation of the independent retraction by the engaged solenoids. The solenoids 360 can also be wired into the overall safety system for the building.

1. An exit bar system for releasably securing a door to a door frame, comprising:
a door frame;
a door mounted to said frame and pivotal about a pivot axis between a closed and an opened position and mounting a push bar on a secured side of said door;
a door latching assembly mounted on the secured side of said door and operated by said push bar and comprising:
a door latch mounted for pivotal movement about a first axis parallel to said pivot axis and having a door latching surface movable between a retracted position and a projected position; and
a frame latching assembly mounted to said door frame comprising:
a frame latch mounted for pivotal movement about a second axis and having a frame latching surface movable toward a projected position;
wherein when said door is in the closed position relative to said door frame, said door and frame latching surfaces are projected and engaged in adjacent opposing, surface-to-surface orientation and a direction of force resulting from an attempt to forcibly disengage said latching surfaces is directed through or close to said first axis.

2. The exit bar system of claim 1 wherein said door latching surface has a claw-like configuration and said frame latching surface is generally complementary to said door claw-like configuration.

3. The exit bar system of claim 1, wherein said door and frame latching surfaces in projected positions engage along an interface generally parallel to said door.

4. The exit bar system of claim 1 wherein said door latching assembly comprises dual transversely spaced door latches and said frame latching assembly comprises two transversely spaced frame latches generally opposite said door latches.

5. The exit bar system of claim 1 wherein upon depressing said push bar, said door latch is forced to a retracted position via a longitudinal translation of a slide assembly.

6. The exit bar system of claim 1 wherein said door latching assembly comprises a platform with a peripheral skirt defining a recess and a longitudinally reciprocating actuator is disposed in said recess.

7. The exit bar assembly of claim 6 wherein said actuator comprises a pair of transversally spaced extensions which each define a diagonal slot.

8. The exit bar system of claim 7 further comprising a pair of actuating rods which extend vertically relative to said latching assembly, and a pin is received in each of said slots for vertically moving said actuator rods upon longitudinal movement of said actuator.

9. The exit bar system of claim 4 further comprising a pair of transversely spaced substantially identical latch housings each having a pair of transversely spaced upright walls and each said latch being pivotally mounted via a pin received in an aperture of a wall.

10. The exit bar system of claim 9 further comprising a coil spring wrapped around each pin, said spring biasing each said latch to a generally projected position.

11. The exit bar system of claim 9 further comprising a carrier disposed between said housing walls and longitudinally slidable relative to said housing and further comprising a retraction arm pivotally mounted to said door latch wherein longitudinal movement of said carrier forces said door latch to retract rearwardly into said latch housing.

12. The exit bar system of claim 11 and further comprising a longitudinally movable actuator operatively connected to said push bar and wherein said carrier is fastened to said actuator.

13. The exit bar system of claim 1 wherein said frame latching assembly comprises a frame latch biasing mechanism to bias said frame latch to the projected position and said frame latching assembly further comprises an override assembly which is biasable to overcome the frame latch biasing mechanism to retract said frame latch to a retracted position.

14. The exit bar assembly of claim 13 wherein said override assembly further comprises a biasable member and said door latching assembly comprises a trigger stop engageable against said member and upon disengagement of said member and said trigger stop, said override assembly forces said frame latch to the retracted position.

15. An exit device system for releasably securing a door to a door frame, comprising:
a door frame;
a door pivotally mounted to said frame and pivotal between an opened and a closed position;
a door latch assembly mounted on said door;
a frame latch assembly with a pivoted frame latch mounted on said door frame;
a first subassembly biasing said frame latch to a projected position;
an overriding assembly exerting a force stronger than said first subassembly, to force said frame latch to a retracted position; and
a trigger stop mounted in fixed relationship with said door, to inhibit said overriding assembly when said door is in a closed position thereby allowing said frame latch to project into engagement with said door latch assembly;
wherein when said door opens, said frame latch is retracted to the retracted position.

16. The exit device system of claim 15 wherein each said door latch assembly and each said frame latch assembly comprises a pair of transversely spaced cooperative latches.

17. The exit device system of claim 15 wherein said overriding assembly comprises a coil spring with an intermediate U-shaped portion which rotatably biases a drive arm, said drive arm being engageable with said trigger stop to inhibit said overriding assembly.

18. An exit device assembly for releasably securing a door to a door frame, comprising:
a door frame;
a door pivotally mounted to said frame and pivotal between an opened and a closed position;
at least one door latch assembly comprising a door latch mounted on said door;
at least one frame latch assembly with a pivoted frame latch mounted on said door frame, each said frame latch assembly being opposite a corresponding door latch assembly, each said door latch assembly comprising a door frame latch biasable to a projected position for engagement with said door latch;
and an overriding assembly capable of exerting force sufficient to force said door frame latch to a retracted position; and
a trigger stop mounted in fixed relationship to said door to inhibit said overriding means when said door in a closed position thereby allowing said frame latch to project into engagement with said door latch;
wherein when said door opens, each said frame latch is forced by said overriding assembly to a retracted position.

19. The exit device assembly of claim 18 wherein each door latch assembly and frame latch assembly comprises a pair of pivotal latch members.

20. An electric dogging mechanism for use with an exit device having a latch operably connected to a push bar mechanism, said electric dogging mechanism comprising:
a base plate;
a push bar mechanism attached to a base plate and having an extended latched position and a depressed retracted latch position for said exit device;
a holding subassembly attached to said base plate for holding said push bar mechanism in said depressed position and thereby holding said latch in a retracted position;
said holding subassembly comprising:
a solenoid plunger attached to said push bar mechanism and a solenoid for holding said push bar mechanism in the depressed position.

21. The dogging mechanism of claim 20 wherein said push bar is elongated and said plunger and push bar generally longitudinally align.

22. An electromechanical system for use with an exit device having a latch comprising:
a push bar mechanism operably connected to said latch and moving said latch into a retracted position when depressed; and
an electromechanical assembly comprising:
a solenoid plunger movable independently from said push bar mechanism and operably connected to said latch to move said latch into a retracted position without depressing said push bar upon power being supplied to said solenoid;
wherein said latch can be retracted simultaneously and independently by said push bar assembly and said electromechanical assembly.

23. The mechanism of claim 22 wherein said electromechanical assembly is located in a housing for said exit device.
